(19) United States
(12) Patent Application Publication
(10) Pub. No.: US 2011/0201254 A1
(43) Pub. Date: Aug. 18, 2011

(54) Methods and Systems for Process Control During Backgrinding of Through-Via Substrates

(76) Inventor: Sharath Hosali, Austin, TX (US)

(21) Appl. No.: 12/707,585

(22) Filed: Feb. 17, 2010

(51) Int. Cl. B24B 49/00; G01N 21/55; B24B 51/00

(52) U.S. Cl. 451/5; 356/448; 451/6

(57) ABSTRACT

Methods and systems for process control during backgrinding of a through-via substrate, such as an embedded through silicon via wafer. A process property value may be sensed and used to determine if a process endpoint has been reached.

### BACKGROUND OF THE INVENTION

The present methods, devices, and systems relate generally to the field of semiconductor fabrication, and more particularly to the backgrinding of substrates to produce through vias.

Fabrication of vertically integrated semiconductor devices, commonly referred to as “3D interconnect,” may involve the formation of through vias by backgrinding a substrate to expose fill material (e.g., conductor material) from the substrate back side (the side of the substrate from which backgrinding process removes material).

Prior backgrinding processes have relied on determination of the total height of the substrate (or substrate stack) from a reference point to determine the process endpoint.

### SUMMARY OF THE INVENTION

Embodiments of the present methods for determining an endpoint during a backgrinding process include backgrinding a substrate having a via and a fill material, sensing a process property value, performing a comparison of the process property value to an endpoint reference value that corresponds to a desired through via exposure, and causing the backgrinding of the substrate to terminate based on the comparison of the process property value to the endpoint reference value. The sensing of the process property value may not include measuring the thickness of the substrate.

In some embodiments of the present methods, the sensing the process property value includes exposing the substrate to a source light that is configured to cause a reflected light to be reflected by the substrate, and measuring a reflected light property.

In some embodiments, the source light comprises UV light. In some embodiments, measuring the reflected light property comprises determining an intensity of the reflected light. In some embodiments, the sensing of the process property value is performed without interrupting the backgrinding of the substrate.

In some embodiments, the backgrinding of the substrate includes using a grinding wheel, the source light is supplied to the substrate by a light source, the reflected light is measured by a light detector, and the source light passes through the grinding wheel to the substrate and/or the reflected light passes through the grinding wheel to the light detector.

In some embodiments of the present methods, the sensing of the process property value includes sensing a property of a waste stream, and the waste stream comprises a waste material that is removed from the substrate during the backgrinding of the substrate.

In some embodiments, the waste material comprises metal ions, and the sensing the property of the waste stream comprises sensing the presence of the metal ions in the waste stream.

Some embodiments further include adding a chemical reagent to the waste stream. The chemical reagent may be configured to assist in sensing the presence of the metal ions.

In some embodiments, the sensing of the process property value is performed without interrupting the backgrinding of the substrate.

Some embodiments of the present systems for performing a backgrinding process include a pedestal configured to support a substrate, a grinding wheel configured to backgrind the substrate, a sensor configured to sense a process property value without measuring the thickness of the substrate, and a controller configured to cause the backgrinding of the substrate to terminate based on a comparison of the process property value to an endpoint reference value that corresponds to a desired through via exposure. The substrate may have a via and a fill material.

Some embodiments of the present systems further include a light source configured to supply a source light to the substrate. The source light may cause a reflected light to be reflected by the substrate, the sensor may include a light detector, and the process property value may include a reflected light property.

In some embodiments, the source light may include UV light. In some embodiments, the reflected light property may include an intensity of the reflected light. In some embodiments, the system is configured such the sensor can sense the process property value without interrupting the backgrinding of the substrate.

In some embodiments, the system is configured such that the source light passes through the grinding wheel to the substrate, and/or the reflected light passes through the grinding wheel to the light detector.

In some embodiments of the present systems, the sensor may include a chemical detector, the process property value may include a property of a waste stream, and the waste stream may include a waste material that is removed from the substrate during the backgrinding the substrate.

In some embodiments, the waste material may include metal ions, and sensing the process property value may include sensing the presence of the metal ions in the waste stream.

Some embodiments further include a reagent injector that is configured to add a chemical reagent to the waste stream. The chemical reagent may be configured to assist in sensing the presence of the metal ions.

Some embodiments may be configured such the sensor can sense the process property value without interrupting the backgrinding of the substrate.

Any embodiment of any of the present methods and systems may consist of or consist essentially of—rather than comprise/include/contain/have—the described functions, steps and/or features. Thus, in any of the claims, the term “consisting of” or “consisting essentially of” may be substituted for any of the open-ended linking verbs recited above, in order to change the scope of a given claim from what it would otherwise be using the open-ended linking verb.

### BRIEF DESCRIPTION OF THE DRAWINGS

The following drawings form part of the present specification and are included to further demonstrate certain aspects of the present methods and systems. The drawings illustrate by way of example and not limitation. Identical reference numerals do not necessarily indicate an identical structure. Rather, the same reference numeral may be used to indicate a similar feature or a feature with similar functionality. Not every feature of each embodiment is labeled in every figure in which that embodiment appears, in order to keep the figures clear.

FIG. 1 depicts one embodiment of the present systems for performing a backgrinding process.

FIG. 2 is a cross-sectional view of the grinding wheel, substrate, and pedestal of an embodiment of the present systems, viewed from plane 2-2 of FIG. 1. Vias and fill material of the substrate are depicted.

FIGS. 3A-3B depict embodiments of the present systems having a source light and a light detector. In the embodiment of FIG. 3B, the system is configured such that the source light and the reflected light pass through the grinding wheel.

FIG. 4 depicts an embodiment of the present systems that has a chemical detector and a reagent injector.

FIGS. 5 and 6 are flow charts depicting embodiments of the present methods for determining an endpoint during a backgrinding process.

### DESCRIPTION OF ILLUSTRATIVE EMBODIMENTS

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. Thus, a method comprising certain steps is a method that includes at least the recited steps, but is not limited to only possessing the recited steps. Likewise, a device or system comprising certain elements includes at least the recited elements, but is not limited to only possessing the recited elements.

The terms “substantially,” “about,” and their variations are defined as being largely but not necessarily wholly what is specified as understood by one of ordinary skill in the art, and in one non-limiting embodiment, the substantially refers to ranges within 10%, preferably within 5%, more preferably within 1%, and most preferably within 0.5% of what is specified.

The terms “a” and “an” are defined as one or more than one, unless this application expressly requires otherwise. The term “another” is defined as at least a second or more.

In one aspect, the present disclosure provides embodiments that are methods for process control during backgrinding of a through-via substrate, such as an embedded through silicon via wafer. Another aspect of the present disclosure provides systems for performing a backgrinding process. These systems may be configured to perform methods for process control during backgrinding of a through-via substrate, such as an embedded through silicon via wafer.

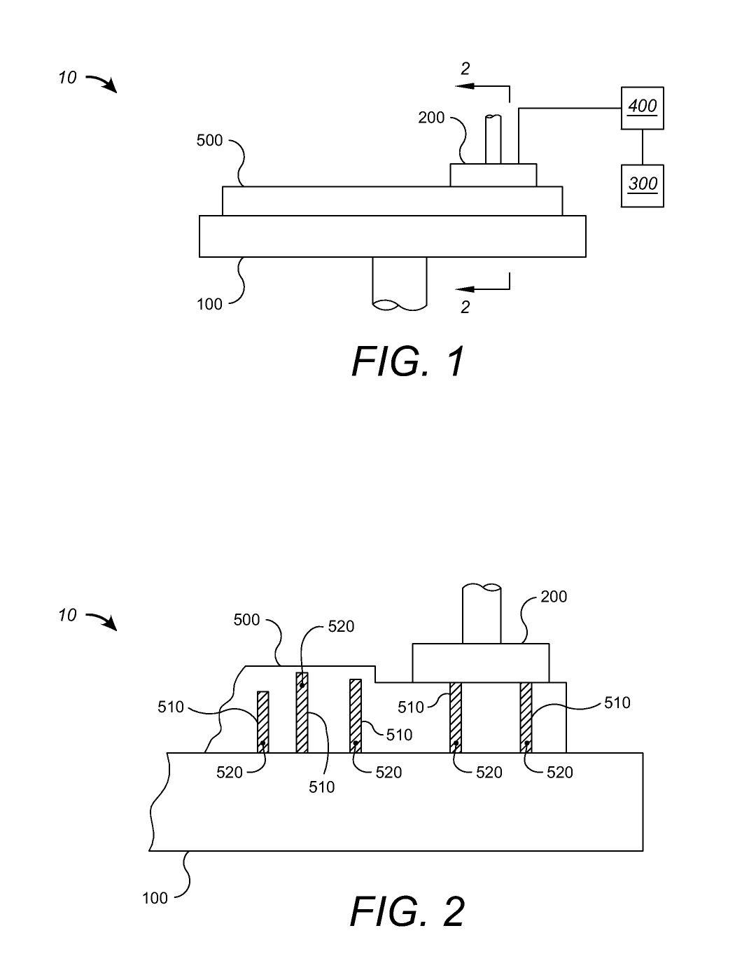

An embodiment of the present system for backgrinding of through-via substrates, such as embedded through silicon via wafers is depicted in FIG. 1. In this embodiment, system 10 is configured to perform a method of process control during backgrinding of embedded through silicon wafers. System 10 may include pedestal 100 that is configured to support substrate 500. Mechanical clamping, electrostatic clamping, vacuum clamping, or any other suitable method for fixing substrate 500 to pedestal 100 may be employed by embodiments of the present systems.

System 10 may also include grinding wheel 200 that is configured to backgrind substrate 500. Grinding wheel 200 may have an abrasive material (e.g., diamond, ceramic, metal) that is configured to remove material from substrate 500 through abrasion accomplished by direct physical contact between grinding wheel 200 and substrate 500. Other embodiments may be configured to remove material from substrate 500 without direct physical contact between grinding wheel 200 and substrate 500. For example, grinding wheel 200 may be configured to cause a material interposed between grinding wheel 200 and substrate 500 to abrade substrate 500 to cause the removal of material. Grinding wheel 200 may be configured to accomplish the direct physical abrasion or the indirect abrasion of substrate 500 via controlled movement of grinding wheel 200. This movement may be, for example, rotational (e.g., a rotating grinding head), linear (e.g., a grinding head that translates in a linear or arced path, or a combination of linear or arced paths), or a combination or rotational and linear (e.g., a rotating grinding head that also translates in a linear or arced path, or a combination of linear and arced paths).

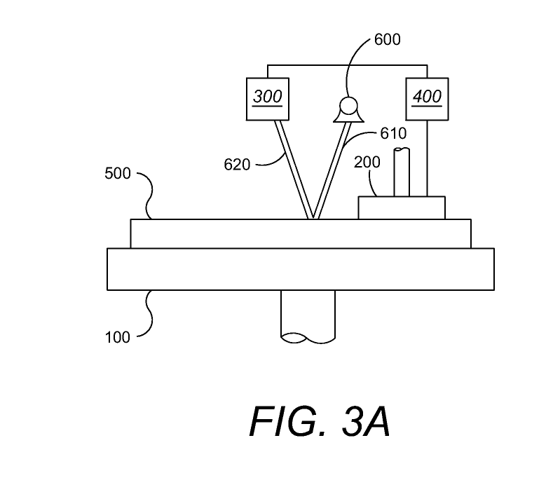

Referring to FIG. 2, substrate 500 may include via 510 that are filled with fill material 520. Substrate 500 may be a silicon wafer, and fill material 520 may be a metal such as, for example, Al, Ti, TiN, Cu, Ta, TaN, W, or any other conductor that may be suitable for use with a silicon wafer. In other embodiments of the present systems, substrate 500 may be a substrate comprising a semiconductor material other than silicon (e.g., GaAs, Germainium) and fill material 520 may be any conductor that may be suitable for use with that semiconductor material. Substrate 500 may be any substrate that is suitable for backgrinding to produce a through-via substrate (e.g., substrates used in the fabrication of integrated circuits, solar cells, liquid crystal displays).

Continuing with FIG. 2, via 510 and fill material 520 may not extend completely through substrate 500 prior to the backgrinding process. Furthermore, each individual via 510 and corresponding fill material 520 may not extend to the same depth within substrate 500 due to fabrication process variations and limitations. For example, reactive ion etch lag effects may cause via 510 of smaller diameter to have shallower depth than via 510 of larger diameter. In other examples, incomplete fill of via 510 during deposition of fill material 520 may result in varying depths of fill material 520. Backgrinding of substrate 500 using grinding wheel 200 may be employed to remove material from substrate 500 to result in substrate 500 that has via 510 and fill material 520 extending completely through substrate 500 (e.g., fill material 520 is accessible at both faces of substrate 500).

Returning to FIG. 1, the backgrinding of substrate 500 may be controlled using sensor 300 and controller 400. Sensor 300 may be configured to sense a process property value during the backgrinding process. In some embodiments of the present systems, system 10 is configured such that sensing the property value does not require interrupting the backgrinding of the substrate, and does not include measurement of the thickness of substrate 500. The process property value may indicate that the backgrinding of substrate 500 has resulted in fill material 520 being exposed. The information from sensor 300 may be used by controller 400 to control the backgrinding process. For example, grinding wheel 200 may be controlled such that the backgrinding terminates when the process property value indicates that a threshold amount of fill material 520 has been exposed. In some embodiments of the present systems, grinding wheel 200 may be controlled such that the backgrinding process adjusts to a less aggressive mode (e.g., slower rate of material removal) when an intermediate threshold value has been reached.

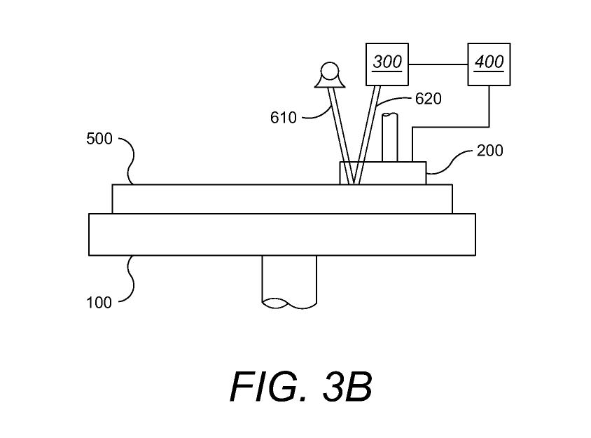

Referring to FIGS. 3A and 3B, some embodiments of the present systems may include light source 600, and sensor 300 that is a light detector. System 10 may be configured such that light source 600 supplies source light 610, which is reflected by the surface of substrate 500 to cause reflected light 620. System 10 may include light source 600 that supplies any suitable wavelength of light, such as, for example ultraviolet (UV) light. Sensor 300 may be configured to sense a property of reflected light 620 such as, for example intensity of source light 610. Fill material 520 may have a higher reflectivity than the substrate material of substrate 500, and therefore the intensity of source light 610 may correspond to the amount of fill material 520 that is exposed at the surface of substrate 500 from which material is being removed. Grinding wheel 200 may be controlled such that the backgrinding terminates when the intensity of source light 610 sensed by sensor 300 indicates that a threshold amount of fill material 520 has been exposed. In some embodiments of the present systems, grinding wheel 200 may be controlled such that the backgrinding process adjusts to a less aggressive mode (e.g., slower rate of material removal) when an intermediate threshold value has been reached.

FIG. 3B depicts and embodiment of the present systems in which system 10 is configured such that source light 610 and reflected light 620 passes through grinding wheel 200. In some embodiments, only source light 610 or only reflected light 620 may pass through grinding wheel 200. In the embodiment depicted in FIG. 3A, neither source light 610 nor reflected light 620 passes through grinding wheel 200. In some embodiments, sensor 300 and/or controller 400 may be integral to the structure of grinding wheel 200.

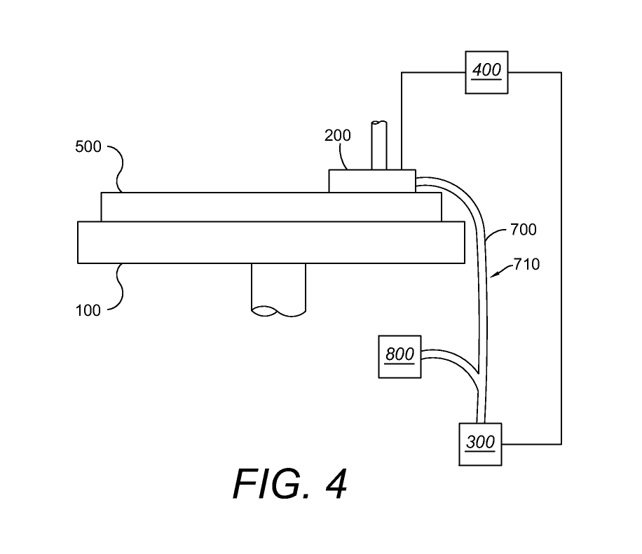

Referring to FIG. 4, some embodiments of the present systems may be configured such that waste stream 700 is sensed by sensor 300. Waste stream 700 my include grinding fluid provided to facilitate removal of waste material 710 that is removed from substrate 500 during the backgrinding process. In some embodiments, the grinding fluid may also serve to remove heat generated during the backgrinding process. In other embodiments in which grinding wheel 200 does not directly contact substrate 500, waste stream 700 may be a fluid interposed between grinding wheel 200 and substrate 500 to abrade substrate 500 to cause the removal of waste material 710 from substrate 500.

Sensor 300 may comprise a chemical detector that is configured to sense the presence of fill material 520 in waste material 710 within waste stream 700. For example, sensor 300 may sense the concentration of fill material 520 in waste material 710 of waste stream 700. This concentration of fill material 520 may correspond to the amount of fill material 520 that is present at the surface of substrate 500 from which waste material 710 is being removed by the backgrinding process. Grinding wheel 200 may be controlled such that the backgrinding terminates when the concentration of fill material 520 sensed by sensor 300 indicates that a threshold amount of fill material 520 has been exposed. In some embodiments of the present systems, grinding wheel 200 may be controlled such that the backgrinding process adjusts to a less aggressive mode (e.g., slower rate of material removal) when an intermediate threshold amount of fill material 520 has been exposed.

Continuing with FIG. 4, some embodiments of the present systems may include reagent injector 800 that is configured to add a chemical reagent to waste stream 700. The chemical reagent may be configured to assist in sensing the presence fill material 520 in waste material 710 of waste stream 700. In some embodiments, the backgrinding of substrate 500 and removal of fill material 520 from substrate 500 may result in the presence metal ions in waste stream 700 or waste material 710. Reagent injector 800 may be configured to add a chemical reagent to waste stream 700 that assists in sensing the presence of the metal ions. For example, chemical reagents may be employed that assist in sensor 300 sensing the presence of specific materials may change the conductivity of waste stream 700, change the color of waste stream 700, and/or cause waste stream 700 to fluoresce.

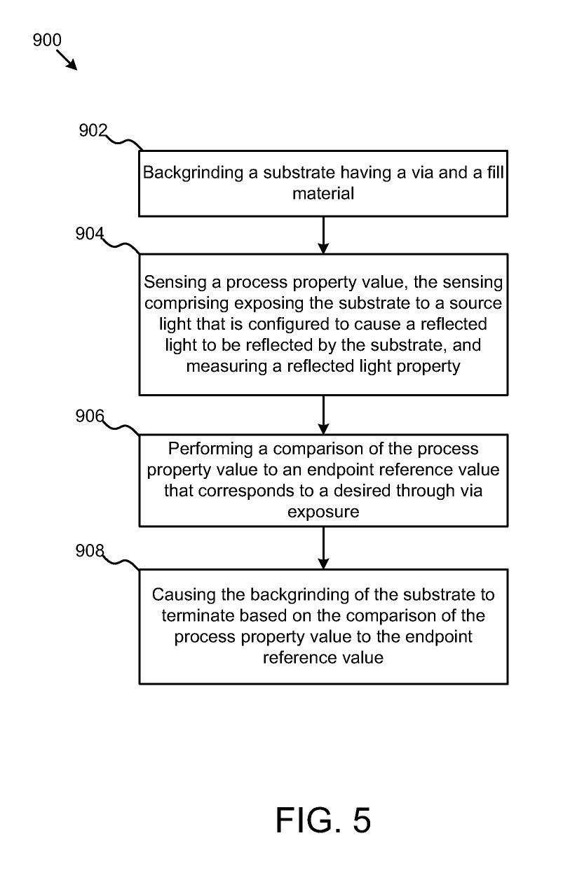

FIG. 5 is a flow diagram illustrating an embodiment of the present methods for determining an endpoint during a backgrinding process that may be performed by, for example, an embodiment of the present systems as described above and depicted in FIGS. 3A and 3B. Method 900 may include: backgrinding a substrate having a via and a fill material (step 902); sensing a process property value, the sensing comprising exposing the substrate to a source light that is configured to cause a reflected light to be reflected by the substrate, and measuring a reflected light property (step 904); performing a comparison of the process property value to an endpoint reference value that corresponds to a desired through via exposure (step 906); and causing the backgrinding of the substrate to terminate based on the comparison of the process property value to the endpoint reference value (step 908).

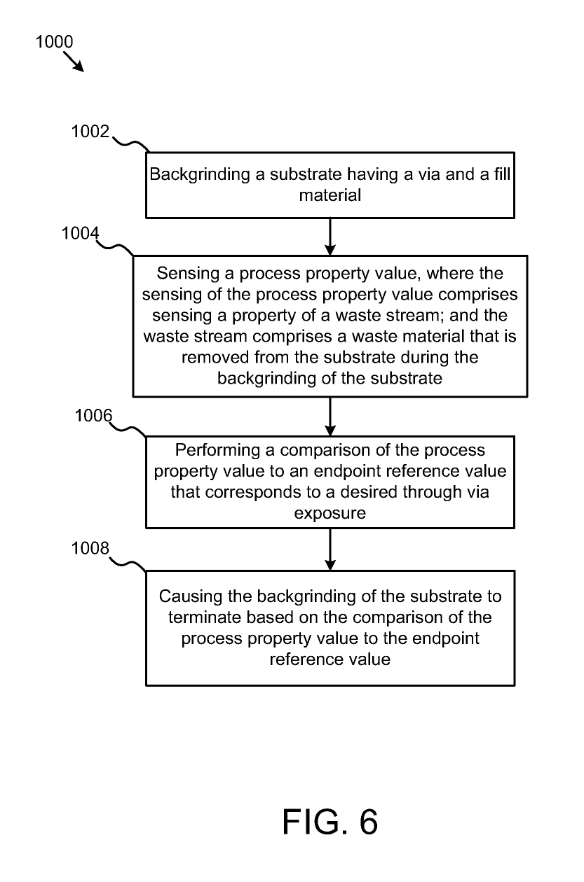

FIG. 6 is a flow diagram illustrating an embodiment of the present methods for determining an endpoint during a backgrinding process that may be performed by, for example, an embodiment of the present systems as described above and depicted in FIG. 4. Method 1000 may include: backgrinding a substrate having a via and a fill material (step 1002); sensing a process property value, where the sensing of the process property value comprises sensing a property of a waste stream, and the waste stream comprises a waste material that is removed from the substrate during the backgrinding of the substrate (step 1004); performing a comparison of the process property value to an endpoint reference value that corresponds to a desired through via exposure (step 1006); and causing the backgrinding of the substrate to terminate based on the comparison of the process property value to the endpoint reference value (step 1008).

It should be understood that the operational flow diagram of FIGS. 5 and 6 are intended only as examples, and one of ordinary skill in the art will recognize that in alternative embodiments certain blocks may be performed in parallel, certain blocks of operation may be omitted completely, and additional operational blocks may be added. Thus, the present methods are not intended to be limited only to the operational flow diagrams of FIGS. 5 and 6, but rather such operational flow diagram is intended solely as an example that renders the disclosure enabling for many other operational flow diagrams for implementing the present methods.

Descriptions of well known assembly techniques, components, and equipment have been omitted so as not to unnecessarily obscure the present methods, apparatuses, an systems in unnecessary detail. The descriptions of the present methods and apparatuses are exemplary and non-limiting. Certain substitutions, modifications, additions and/or rearrangements falling within the scope of the claims, but not explicitly listed in this disclosure, may become apparent to those of ordinary skill in the art based on this disclosure. For example, the fixing of substrate 500 to pedestal 100 may be accomplished by for example, various methods of mechanical clamping and/or electrostatic clamping.

The appended claims are not to be interpreted as including means-plus-function limitations, unless such a limitation is explicitly recited in a given claim using the phrase(s) “means for” and/or “step for,” respectively.

What is claimed is:

1. A method for determining an endpoint during a backgrinding process, comprising:
backgrinding a substrate having a via and a fill material;
sensing a process property value, where sensing the process property value does not comprise measuring the thickness of the substrate;
performing a comparison of the process property value to an endpoint reference value that corresponds to a desired through via exposure; and
causing the backgrinding of the substrate to terminate based on the comparison of the process property value to the endpoint reference value.

2. The method of claim 1, the sensing the process property value comprising:
exposing the substrate to a source light that is configured to cause a reflected light to be reflected by the substrate; and
measuring a reflected light property.

3. The method of claim 2, the source light comprising UV light.

4. The method of claim 2, the measuring the reflected light property comprising determining an intensity of the reflected light.

5. The method of claim 2, the sensing of the process property value being performed without interrupting the backgrinding of the substrate.

6. The method of claim 5,
the backgrinding of the substrate comprising using a grinding wheel;
the source light being supplied to the substrate by a light source;
the reflected light being measured by a light detector; and
at least one of:
the source light passing through the grinding wheel to the substrate; and
the reflected light passing through the grinding wheel to the light detector.

7. The method of claim 1,
the sensing of the process property value comprising sensing a property of a waste stream; and
the waste stream comprising a waste material that is removed from the substrate during the backgrinding of the substrate.

8. The method of claim 7,
the waste material comprising metal ions; and
the sensing the property of the waste stream comprising sensing the presence of the metal ions in the waste stream.

9. The method of claim 8, further comprising adding a chemical reagent to the waste stream, the chemical reagent being configured to assist in sensing the presence of the metal ions.

10. The method of claim 7, the sensing of the process property value being performed without interrupting the backgrinding of the substrate.

11. A system for performing a backgrinding process, the system comprising:
a pedestal;
a grinding wheel configured to backgrind a substrate supported by the pedestal, the substrate having a via and a fill material;
a sensor configured to sense a process property value without measuring the thickness of the substrate; and
a controller configured to cause the backgrinding of the substrate to terminate based on a comparison of the process property value to an endpoint reference value that corresponds to a desired through via exposure.

12. The system of claim 11, further comprising a light source configured to supply a source light to the substrate, the source light causing a reflected light to be reflected by the substrate, and where:
the sensor comprises a light detector; and
the process property value comprises a reflected light property.

13. The system of claim 12, the source light comprising UV light.

14. The system of claim 12, the reflected light property comprising an intensity of the reflected light.

15. The system of claim 12, the system being configured such the sensor can sense the process property value without interrupting the backgrinding of the substrate.

16. The system of claim 15, the system being configured such that at least one of:
the source light passes through the grinding wheel to the substrate; and
the reflected light passes through the grinding wheel to the light detector.

17. The system of claim 11,
the sensor comprising a chemical detector;
the process property value comprising a property of a waste stream; and
the waste stream comprising a waste material that is removed from the substrate during the backgrinding the substrate.

18. The system of claim 17,
the waste material comprising metal ions; and
sensing the process property value comprising sensing a presence of the metal ions in the waste stream.

19. The system of claim 18, further comprising a reagent injector that is configured to add a chemical reagent to the waste stream, the chemical reagent being configured to assist in sensing the presence of the metal ions.

20. The system of claim 17, the system being configured such the sensor can sense the process property value without interrupting the backgrinding of the substrate.
